(19) United States
(12) Patent Application Publication
(10) Pub. No.: US 2008/0271999 A1
(43) Pub. Date: Nov. 6, 2008

(54) Composite Conductive Material

(75) Inventors: Colin John Francis Philip Jones, York (GB); John Lamont-Black, Newcastle Upon Tyne (GB); Stephanie Glendinning, Northumberland (GB)

Correspondence Address: IPLM GROUP, P.A., POST OFFICE BOX 18455, MINNEAPOLIS, MN, 55418, US

(73) Assignee: Electrokinetic Limited

(21) Appl. No.: 11/576,417

(22) PCT Filed: Sep. 30, 2005
(86) PCT No.: PCT/GB2005/003764

§ 371 Date: Jul. 21, 2008

(30) Foreign Application Priority Data
Oct. 7, 2004 (GB) 0421855.8

(51) Int. Cl. C02F 1/469; B32B 15/04

(52) U.S. Cl. 204/450; 428/469

(57) ABSTRACT

A composite conducting material is described comprising a non-conductive polymeric base material, and for example a geosynthetic or like material, in association with at least one primary conducting electrode element comprising a metallic core element coated with a coating of mixed metal oxides such as oxides and/or suboxides of tantalum, niobium, iridium, palladium, ruthenium, rhodium, titanium and mixtures thereof. The material disposed as an electrode, for example in an electrokinetic circuit, for the treatment of materials such as highly watered and/or highly saline substrates by electroosmosis, is also described.

The invention relates to composite conducting materials, in particular for use in electrokinetics, for example as electrodes in an electrokinetic system. The invention relates to composite conducting materials in various forms, including sheets, tubes, belts, bags, strips, grids or other forms, or more complex structures formed from combinations thereof.

Electrokinetics comprises five phenomena: (i) streaming potential, (ii) sedimentation potential, (iii) electroosmosis, (iv) electrophoresis and (v) ion migration. The first two phenomena produce potential differences as a result of the relative movement of solids and liquids, whereas the latter three phenomena require that a potential gradient is applied and maintained throughout a material within which the phenomena are to be manifest. A potential gradient is achieved by applying a voltage across a material such as soil, sludge, slurry or tailings using electrodes. If the material is electrically conductive, then the applied voltage will cause a current to flow in the circuit. The overall current in the circuit comprises the physical movement of charge through the material as characterised by the electrokinetic phenomena and electrochemical reactions that occur at the anode(s) and cathode(s). Therefore, comparing materials of varying electrical conductivity, those with a high electrical conductivity will conduct more electricity under a given voltage than those with a lower electrical conductivity. This difference is likely to be reflected in the magnitude of ion migration but is not necessarily reflected in the other electrokinetic phenomena of electroosmosis and electrophoresis.

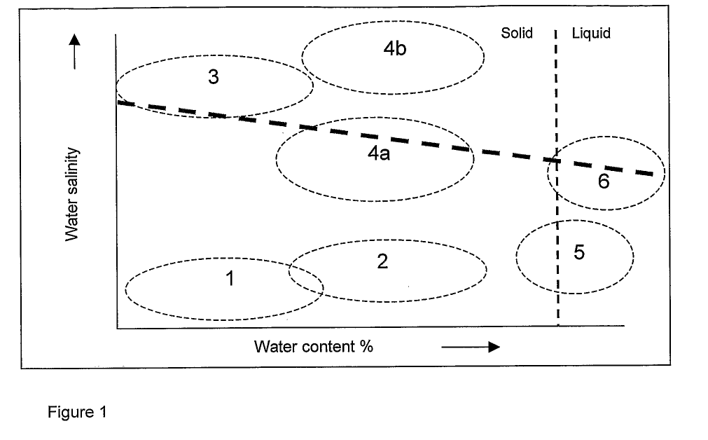

Electrical conductivity of the material increases as a function of both the water content of the material and the salinity of that water. According to the defining characteristics of water content and water salinity, as shown in FIG. 1, the range of treatable materials fall into six broad categories four of which are loosely grouped as solids (1-4) and two as liquids (5 & 6). The situation is shown graphically in FIG. 1. These parameters help to define the amount of electricity used in treatment such that:
The more conductive the material is then the greater will be the current flow caused by maintaining the voltage gradient
The higher the moisture content the material has will mean that, under normal circumstances, a longer period of electrokinetic treatment will be required

According to Ohm's Law, the current passed in the circuit is proportional to the applied voltage and inversely proportional to the resistance of the circuit. The latter comprises power supply, cables, electrodes and treatable material. Changes in resistance typically occur as a result of physical and chemical changes in the electrodes and the treatable material. Such changes particularly those occurring in the electrodes and at the electrode/treatable material contact usually result in a significant drop in the voltage which is actually applied across the material. Such changes include:
Gradual dessication of the anode thus increasing electrode/material contact resistance
Production of gasses that reduce the contact area between electrode and material
Corrosion of the anode resulting in
   reduced surface area of contact between electrode and material
   complete breakdown of anodes in some areas
   increased surface resistance of the anode
   production of complex oxidation and reduction products which increase the resistance of the system

The above changes vary according to the type of material that is being treated. With reference to FIG. 1, the least challenging materials to treat are group 1 i.e. terrestrial soils. The other materials comprise materials which are either:
Highly conductive
High water content
Both highly conductive and with a high water content

It has been found that in order to effect treatment in these different types of materials, the materials which comprise the electrodes must be carefully chosen in order to manage the above mentioned voltage drop.

This drop in voltage causes a reduction in the rate of electrokinetic flow phenomena and also a drop in the current in the circuit. It is the intention of the present invention to construct anodes and cathodes in such a way as to control the above voltage modifying effects by the carefully choosing the blend of materials.

Previous patents and applications such as WO95/21965, WO00/39405, WO00/46450, WO02/02875, WO03/093499 and GB0323068.7 describe the structure and operation of electrokinetic geosynthetic materials for processes such as ground consolidation, ground conditioning, turf conditioning and in situ and process dewatering of wastes such as sludges, slurries and tailings. (It should be noted that in this context reference to a geosynthetic material is intended to be read as a reference to a material type or class, whether or not its intended use is in a ground substrate as a geosynthetic in the narrow sense.)

It will be understood, both in the context of the prior art referred to above, and in the context of a conductive material in accordance with the invention, that the EKG or other composite material acts as an ‘electrode’. It is comprised of conducting and non conducting materials. The conducting materials may be of more than one type and they may vary in composition, size, number, electrical resistivity and resistance to corrosion. The non conducting materials may be of more than one type and they may vary in composition size, strength, flexibility and other factors such as filtration characteristics, drainage characteristics, separation characteristics and reinforcement characteristics.

For the reasons noted above, such conducting materials and structures have been particularly effective in treating materials of type 1 on FIG. 1, being terrestrial soils. These are the least challenging materials in this context. Known conductive materials such as those described in the patents and applications referred to are not always effective in more highly saline and/or wetter environments, where the increase in the above listed effects reduces the effective working life of any electrode as it corrodes more rapidly. For many applications, a satisfactory working life, necessary if the technique is to be commerically viable, is difficult to achieve with known conducting electrokinetic geosynthetic (EKG) materials. Accordingly, corrosion effects have placed limitations on the practical applicability of the use of conducting electrokinetic geosynthetics and like materials in the treatment of such substrates.

It is an object of the invention to provide a composite conducting material, in particular for use as an electrode in an electrokinetic system, which mitigates some or all of the above disadvantages.

It is a particular object of the present invention to provide an electrode material for use in an electrokinetic system for the treatment of substrates comprising an environment of high salinity and/or liquid content which offers enhanced corrosion resistance and enhanced useful life.

It is a particular object of the present invention to provide an electrode material that allows the principles of treatment of material by EKG structures in the patents and applications referred to hereinbefore to be extended to a greater range of substrate materials, in particular to be extended effectively to materials such as estuarine and marine soils and dredgings, wet mine tailings, mineral sludges and sewage sludges.

Thus, in accordance with the invention in a first aspect there is provided a composite conducting material comprising a non-conductive polymeric base material in association with at least one electrode element comprising a metallic element coated with a coating of mixed metal oxides.

Large-scale monolithic metallic anodes with a mixed metal oxide (MMO) coating are known in the specific field of cathodic protection, as being an effective form of anode for demanding environments. It will be appreciated that in this context, mixed metal oxide (MMO) is a term which will be understood as having a specific meaning in the art. Suitable oxide mixtures are described herein below.

Cathodic protection anodes are large, typically solid structures which are intended to remain statically in a corrosive environment as an anode for periods as long as several decades. The requirements for structures for incorporation into composite conductors of the present invention are very different, and in particular, as will be appreciated from the examples described hereinbelow, the structural requirements for each conductive element, requirements of size, and the intimate relationship with the non-conducting base material, create a very different series of problems. Nevertheless, it has been surprisingly found that these conductors, incorporated to make up at least some of the conductive elements in a composite conductive material in accordance with the invention, offer a simple and effective solution to the problem of creating a sufficiently resistant composite electrode for the more difficult environments to which the invention is particularly intended to apply.

The at least one conducting element is associated with the non-conducting substrate to comprise a composite conducting material suitable for use as an electrode, for example in an electrokinetic system. In particular, the conducting element is in intimate integral association with the non-conducting material, for example being incorporated within or on a surface of the structure thereof.

The composite conducting material in accordance with the invention preferably includes a plurality of conducting elements as hereinbefore described disposed or arrayed within and/or on the surface of the non-conductive material. Additional secondary conducting elements comprising materials other than metal coated with MMO may be included along with the primary metal coated with MMO conducting elements.

The primary conducting elements comprise a conductive metallic core, having a coating of MMO, preferably substantially entirely coating the said core. Any suitable metallic core material may be used. In harshly corrosive environments, and/or to allow for imperfections and/or damage to the coating the metallic material forming the core is preferably a material capable of forming an effective passivating oxide layer, such as for example titanium, niobium, zirconium and alloys thereof. If environmental and/or service life considerations allow, a core formed of a metal exhibiting a lesser but still reasonable degree of stability in the corrosive environment such as stainless steel or copper might be acceptable.

The technology of coating with MMO is established, and the skilled person will readily understand the materials encompassed by this term. In particular, the coating should comprise materials selected from the oxides and/or suboxides of tantalum, niobium, iridium, palladium, ruthenium, rhodium and mixtures thereof. Coatings of or including oxides and/or suboxides of titanium may also be used where the core material and/or conditions of use are suitable. The MMO coatings are of an appropriate thickness to last for the duration of the treatment and/or the intended service life of the component to be fabricated from the material in accordance with the invention (calculated according to the circuit current and treatment duration).

The non-conducting polymeric material forms a base for the composite electrode structure, and is selected to have properties suitable to give the required integrity to the structure. In particular, the non-conducting material is selected also for an additional geosynthetic or geosynthetic-type function, including drainage, filtration, substrate reinforcement, or any other such known property of a geosynthetic material. Accordingly, the non-conducting substrate is, in a particularly preferred embodiment, a material known for use as a geosynthetic material in geosynthetic applications, and for example a material of the type described in the patents and applications relating to such geosynthetic applications referred to hereinabove. The electrode thus comprises a conducting electrokinetic geosynthetic (EKG) electrode.

The composite conductive material may be provided in various forms, including sheets, tubes, belts, bags, strips, grids or other forms, or more complex structures formed from combinations thereof. In a possible embodiment, the material may be provided in sheet form, for example composed as a flexible elongate sheet material. In this sheet form, the or each conducting element preferably comprises an elongate conducting element disposed within or on the surface of the sheet. In particular, the or each conducting element comprises a rod, wire, tape or like structure arrayed within the sheet.

The conductive material is conveniently a textile having a primarily polymeric base structure. The textile may be woven, knitted, needle-punched, extruded, non-woven or otherwise fabricated. Woven and knitted structures are especially preferred. The textile includes conducting elements within or on the material structure in intimate association, for example within a sheet structure, and in particular woven or knitted into a woven or knitted sheet. Particularly suitable materials will include those materials known for use as conducting geosynthetic materials.

In the preferred case therefore, an electrokinetic geosynthetic type material is used. This can provide all the functions of a conventional geosynthetic material (i.e. drainage, filtration and reinforcement) as well as acting as an electrode.

The principal conducting elements in accordance with the invention comprise dimensionally stable elements, having a metal core coated in a blend of mixed metal oxides. These dimensionally stable elements provide the stability to function as anodes or cathodes depending on the state of the plurality of the circuit. In particular, they result in the creation of a composite electrode material capable of being used as the anode or cathode, and in particular the anode, in an electrokinetic circuit incorporating a substrate set up to drive an electro-osmotic process for dewatering, consolidation, or other treatment reasons.

A possible undesirable side effect of applying the principles of electro-osmosis to such more difficult materials is the generation of gas at the electrodes as a result of electrochemical reactions which are occuring at electrodes as a result of processes necessary to maintain voltage across the material. The generation of gas can dramatically degrade electrode performance.

To address this, in a particularly preferred embodiment, a composites conducting material in accordance with the invention may be further associated (in addition to the at least one primary conducting element comprising metal coated with MMO) with at least one secondary conducting element selected to be sacrifical relative to the primary conducting element in use. Preferably, the composite conducting material comprises a plurality of such primary conducting elements and a plurality of such secondary conducting elements disposed within and/or on a surface of its structure.

The primary conducting elements constitute dimensionally stable components in use. The secondary conducting elements are selected to be sacrifical when the conducting material is in use as an electrode in a corrosive environment, and in particular as an anode in an electrokinetic circuit arrangement as discussed herein. The composite conducting material in accordance with this preferred embodiment of the invention may comprise a mixture of sacrifical and dimensionally stable electrode elements, which in particular is chosen to limit anodic desiccation, modify gas production, modify and control pH and control anodic corrosion in use. The mixture of dimensionally stable and sacrifical elements is chosen to function within a cathodic environment with sufficient sacrifical capacity to function as an effective anode during reverse plurality phases if required.

Surprisingly, in accordance with this possible embodiment, it has been found that improvements to the effectiveness of EKG materials acting as electrodes can be achieved for some applications by a composite mixture of sacrificial anodic elements and dimensionally stable anodic elements. However, the presence of sacrificial elements is an entirely optional preferred feature of the invention where such an embodiment is desirable, and the invention is not limited to materials including such sacrificial elements.

By forming parts of the anode to be formed so as to corrode during use, anodic dessication adjacent to the electrode can be reduced. In addition gas production is modified (reduced) which is particularly beneficial as electroosmosis can otherwise be severely limited or effectively cease due to insulation by hydrolytically evolved gases. In addition the release of metal ions from the sacrificial components of the anode serves to modify the preformance of the pore fluid in the treatible material and thus the electroosmotic flow.

Further consequences of this designed release of cations includes changes in porewater salinity, modification of generated pH gradients, and zeta potential at solid/porewater interfaces. Furthermore, careful choice of the blend of sacrificial metal elements in the anode allows optimal exchange of cations in soil materials thus leading to an increase in the shear strength and an improvement in mechanical handling characteristics of the treated material.

It is the contention of this application that the inventions contained herein offer economic solutions to electrokinetic treatment that can be achieved by improving the inventions contained in previous patents. EKGs have been and are routinely fabricated from a composite mixture of metallic and non metallic elements.

The sacrificial elements comprise materials which are dimensionally unstable in anodic conditions. Preferred embodiments include iron, steel, aluminium or carbon.

Electrodes formed from this material are operated to force the dissolution of sacrificial elements. The dissolution products then become solutes in the water phase in the the material to be treated and thus contribute to changing porewater salinity and pH, causing cation exchange and optimising the zeta potential and thus maximising electrokinetic flow phenomena.

Sacrificial elements contribute to electrode reactions to maintain the voltage across the material whilst reducing or eliminating the contribution to the evolution of hydrolytic gasses, thus reduce the loss of contact area associated with gas evolution.

Sacrificial elements are blended within an EKG or other substrate according to element thickness, length and element anodic consumption rate (measured in kg per amp year) in a given environment to provide gradual corrosion of sacrificial elements over a desired period of time.

Sacrificial materials are used to optimise pH changes in the materials and thus minimise or postpone the rise in ciruit resitance as a result of the interaction of acid and alkali fronts in the treated material.

In accordance with the invention in a further aspect, a composite electrode comprises a composite conducting material as hereinbefore described. In particular, the electrode is provided in sheet or other suitable form, and is configured of a suitable substrate material to confer a reinforcement and/or filtration and/or drainage or other dewatering function. The electrode is particularly suited for use in an electrokinetic system, in particular as an anode, and in particular for the treatment of highly watered and/or highly saline substrates by electro-osmosis.

In accordance with the invention in a further aspect, an electrokinetic circuit comprises at least one first electrode, at least one second electrode remotely spaced therefrom with a substrate to be treated lying therebetween, and a means to apply a potential difference thereacross to drive an electro-osmostic process within the substrate, wherein at least one of the electrodes is an electrode in accordance with the foregoing. In particular, the substrate is a material of high water content and/or high salinity, and at least the electrode intended to function as the anode in use is an electrode in accordance with the principles of the invention.

In one suitable embodiment, each electrode is disposed within a ground substrate to effect electro-osmotic consolidation and/or electro-osmostic drainage or other dewatering and/or other conditioning of the said ground substrate.

In an alternative embodiment, the system comprises a system for the treatment of non-ground substrates such as waste materials, for example slurries, sludges and tailings, the system being for example a dewatering system such as a static filter cell or belt filter press.

In particular, it will be appreciated by the skilled person that an electrode material in accordance with the invention is suitable for incorporation into the range of systems and geosynthetic and other structures set out in the previous patents and applications referred to hereinabove, in situations and environments where electrodes with the particular properties and advantages of the present invention would be beneficial.

The invention will now be described by way of example only with reference to FIGS. 1 to 4 in which:

FIG. 1 illustrates conceptually the relationship of water salinity vs water content for the range of materials it might be desirable to treat electrokinetically with example materials shown on a plot of salinity against water content (note that electrical conductivity is a function of the combination of these factors);

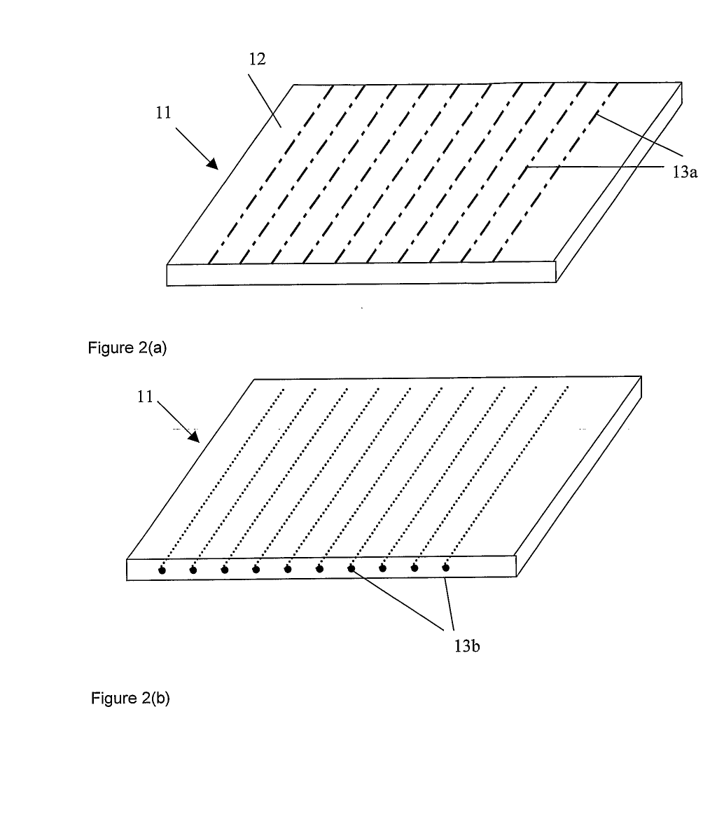

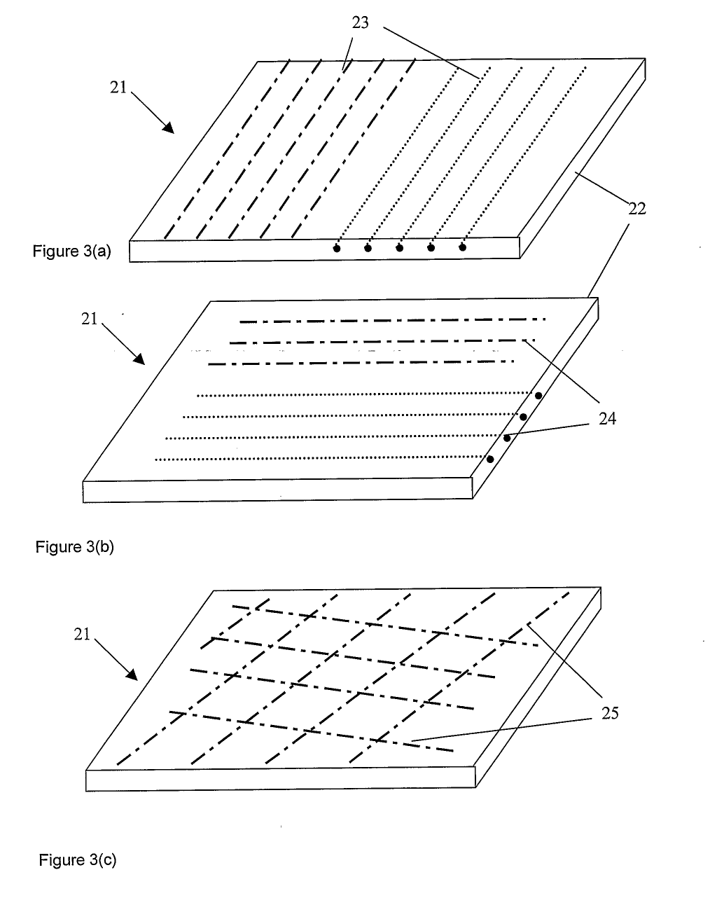

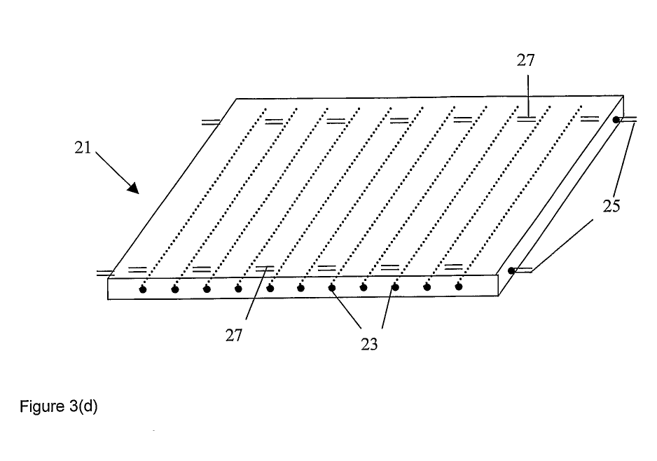

FIGS. 2 and 3 are representations of a suitable arrangement for an embodiment of the invention suitable also for use as a filtration membrane, for example in a filter press;

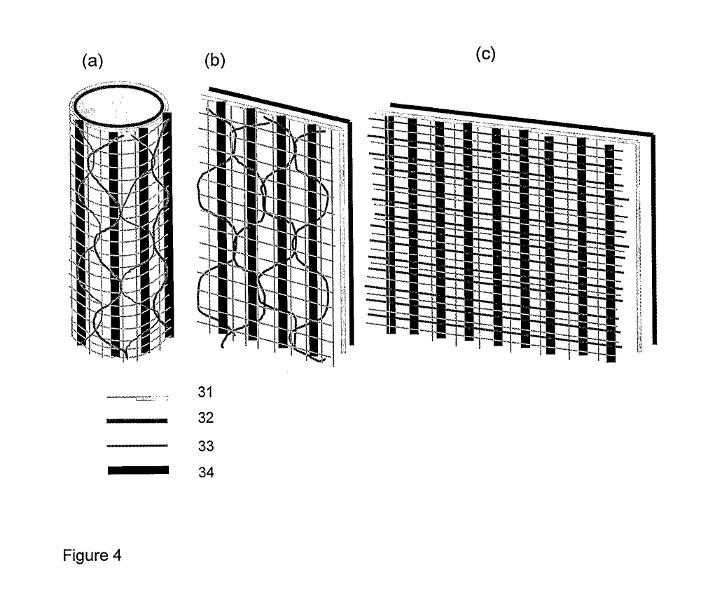

FIG. 4 is a representation of a suitable arrangement of an embodiment of the invention suitable for use as an electrokinetic prefabricated vertical drain (ePVD) or electrokinetic wick drain.

FIG. 1 illustrates conceptually the relationship of water salinity vs water content for the range of materials it might be desirable to treat electrokinetically. This has been discussed in detail hereinabove. Example materials, in increasing order of environmental harshness and difficulty of handling, are terrestrial soils (1), construction wastes (2), marine soils (3), estuarine (4a) and marine (4b) dredgings, mine tailings and mineral sludges (5), and sewage sludges (6).

The electrodes of the invention are particularly suited to high conductivity regimes, which might be outside the practical working range with adequate commercial lifetime for more conventional conducting EKGs and like structures, such as those described in the patents and applications hereinbefore referred to. It should be noted that electrical conductivity is a function of the combination of these factors.

Electrodes in accordance with the principles of the invention may be used in a range of applications. In particular they may combine EKG type functions of drainage and/or reinforcement and/or filtration. FIGS. 2 to 3 illustrate sheet materials suitable for use as a filtration membrane, for example as a belt in a belt filter press or as a filtration sheet for a cell for a batch system such as a plate filter press. Sheet materials are illustrated as an example only of a possible conformance of the material of the invention, which may be in any suitable form for the intended application.

In each case a woven sheet or belt 11 is formed from a base of woven polymeric material 12, to that extent comprising for example a conventional geotextile or geotextile-like material providing a drainage and filtration function. Suitable materials will include polyester, polypropylene and polyamides.

A parallel array of elongate conductors is provided in association with the sheet or belt 11. At least some of these conductors are metal coated with mixed metal oxides. Other conductors may be of a composition designed to be sacrificial in use.

Two alternative arrangements are shown. In FIG. 2a a first array of elongate conductors 13a is disposed on an upper surface 12 of the sheet or belt 11 in intimate contact therewith and a second array of elongate conductors (not shown) is disposed on a lower surface. In FIG. 2b a single array of elongate conductors 13b is disposed within the sheet or belt 11.

In FIG. 3a a woven or knitted textile sheet 21 is formed from a base of polymeric material 22 into which is incorporated, preferably woven or knitted into the structure, a parallel array of elongate conductors 23, lying parallel to a warp direction. In FIG. 3b a parallel array of elongate conductors 24 is woven or knitted into the sheet 21 to lie generally in a weft direction. In FIG. 3c the elongate conductors 25 form a two-dimension network by being angled relative to the warp and weft directions of the sheet.

A particularly preferred specification for a filtration/electrode sheet as illustrated in FIGS. 2 and 3 is set out in detail below. The sheet is described dimensioned as a belt for use in a belt filter press. Conformance as a sheet for use in a belt press is an illustrative example only of the range of materials and uses to which the invention can be applied. It is illustrated in FIG. 3d.

FIG. 3d is a textile sheet (21) with conductors (23) provided (in this example) in a weft direction which will be perpendicular to a direction of belt travel in use. The conductors (23) are embedded within the sheet, so the design problem becomes providing an external contact for applying a current.

In the embodiment, electrical transfer is achieved by means of the warp transfer elements (25). These are conductors woven into the sheet (21) to effect contact with the conducting elements (23) but to thread through the textile in such manner as to successively periodically be exposed on each surface at the points (27, and underside not shown) and provide contacts for a current transfer means.

There are four elements to the design for which an example specification is provided below:
1. Belt weave design
2. Insulation of the electrical components of the belts
3. Choice of materials for the conducting elements of the anode and cathode belts.
4. Electrical transfer method.

### Weave and WTS (Warp Transfer Strip) Design

Based on a weave comprising warp diameter of 0.65 mm, weft diameter of 0.80 mm, 15 warp elements per cm and 6 weft elements per cm:
Total belt width=2200 mm
Width of WTS=60 mm
Width of opposing WTS=20 mm
WTS formed with metallic wires only i.e. 90 warp wires in WTS
Opposing WTS formed with alternating metal and polyester wires i.e. 15 metal wires in a width of 20 mm
Weft wires spaced at 5 mm

### Belt Insulation

The aim of belt insulation is to ensure that all the current between the anode belt and the cathode belt passes through the sludge rather than shorting owing to direct contact of the belts.

In reality is it unlikely that it will always be possible to prevent occasional contact of the belts. This is most likely to occur at the edges, therefore some form of insulation along the edges is suggested—similar to what might be used around the clipper seam (the seam joining the two ends of the belt to form a continuous belt). The precise scheme is not critical to the invention.

The materials used for insulating the belt should have a high electrical resistivity i.e. function as an insulator. Voltages of 0-40V are typical. Most insulators are designed for much higher operating voltages than this, so leakage of current through the insulator should not be a problem.

Assuming that the insulator strips remain intact and are not punctured, it is likely that if any electrical shorting does occur then it will occur via liquid films coating the surface of the insulator. With this in mind the insulator should also be hydrophobic i.e. maintain a high contact angle with water in order to produce a non-wetting surface and thus to help to isolate droplets of water.

### Materials

### Anode Wires

Anode wires of 0.8 mm and 0.65 mm diameter, that could be titanium, stainless steel or copper coated with mixed metal oxide (MMO). The MMO could be an iridium-tantalum-based material of the type used for oxygen evolution in cathodic protection applications.

### Cathode Wires

Cathode wires should utilise stainless steel or other metallic materials with a similar blend of resistance to corrosion and electrical resistivity.

### Electrical Transfer

As described above in the weave design the electrical transfer is achieved via one or more warp transfer strips (WTS). These are in electrical contact with a plurality of electrical brushes including carbon or carbon copper composites. Different voltages can be applied along the length of length of the belts to optimise the electroosmotic effect and control power consumption. This electrical transfer method provides for the pickup and discharge of current to the moving belts.

The invention thus provides an admirable way to apply the principles of electrokinetic dewatering based on the principles established for conducting EKGs to high conductivity environments where known EKGs are of limited practical application.

FIG. 4 shows further example embodiments of the invention. Examples are shown with the flexible composite electrode material conformed as a sock (a), strip (b) or sheet (c). Each of the above embodiments provides a suitable form for functioning as an ePVD.

Each structure comprises the same basic material components, a base fabric or mesh (31), a filter fabric (32), primary carriers (34) (which are typically dimensionally stable), and secondary distributors (33) (which may be sacrificed and/or dimensionally stable).

The sock may be inserted into the material to be treated in the form shown in FIG. 4. The strip may be inserted into the material to be treated in the form shown or more prefereably folded along its longitudinal axis either before or at the moment of insertion. The sheet or grid may be inserted into the ground as shown or more prefereabley folded along its longidutinal axis before insertion or at the moment of insertion or alternatively the sheet may be cut into several longitudinal sections to resemble a strip and treated subsequently. In folding the material before or as it goes into the ground it should be folded in such a way that the conductive elements are on the outside, i.e. in contact with the soil, with the filter fabric on the inside.

The three embodiments comprise primary axial current carriers which are conductive and preferably coated with MMO. Secondary distributors are conductive and function to distribute the current across the greater part of the surface of the ePVD. Secondary distributors may be dimensionally stable and/or sacrificial.

The conductive elements above are attached to or integrally incorporated within a base fabric or mesh. This is shown in this embodiment as comprising a mesh and a filter fabric.

It should be noted that depending on electrode arrays the anode and cathode ePVDs, as designated at the commencement of normal phase treatment, are unlikely to be identical in terms of the relative combinations or compositions of the four elements identified. Principally, electrodes used in the normal polarity phase as cathodes will have a lower proportion of components made up of materials incorporating MMOs in accordance with the invention and/or a higher proportion of components made of other materials compared to the anodes.

1. A composite conducting material comprising a non-conductive polymeric base material in association with at least one primary conducting electrode element comprising a metallic core element coated with a coating of mixed metal oxides.

2. A composite conducting material in accordance with claim 1 wherein the at least one conducting element is in intimate integral association with the non-conducting material, being incorporated within or on a surface of the structure thereof.

3. A composite conducting material in accordance with claim 2 comprising a plurality of conducting elements disposed or arrayed within or on the surface of the non-conductive material.

4. A composite conducting material in accordance with claim 1 wherein the core material is a material capable of forming an effective passivating oxide layer.

5. A composite conducting material in accordance with claim 1 wherein the core material comprises titanium, niobium, zirconium, stainless steel or alloys thereof.

6. A composite conducting material in accordance with claim 1 wherein the coating materials comprise the oxides or suboxides of tantalum, niobium, iridium, palladium, ruthenium, rhodium, titanium or mixtures thereof.

7. A composite conducting material in accordance with claim 1 wherein the non-conducting polymeric material provides an additional geosynthetic or geosynthetic-type function, including drainage, filtration, substrate reinforcement, or other property of a geosynthetic material.

8. A composite conducting material in accordance with claim 1 wherein the non-conducting polymeric material is a geosynthetic material.

9. A composite conducting material in accordance with claim 1 comprising a flexible elongate sheet material or a structure formed therefrom wherein the or each conducting element comprises an elongate conducting element comprising a rod, wire, tape or like structure disposed within or on the surface of the sheet.

10. A composite conducting material in accordance with claim 9 wherein the sheet material is a textile having a primarily polymeric base structure.

11. A composite conducting material in accordance with claim 10 wherein the sheet material is a woven or knitted textile with conducting elements woven or knitted into the sheet material.

12. A composite conducting material in accordance with claim 1 further comprising a least one secondary conducting element comprising materials other than metal coated with mixed metal oxide additional to the or each primary conducting element comprising metal coated with mixed metal oxide.

13. A composite conducting material in accordance with claim 12 comprising at least one primary conducting element selected to be dimesionally stable in use and at least one secondary conducting element selected to be sacrifical relative to the primary conducting element in use.

14. A composite conducting material in accordance with claim 13 wherein the sacrificial element is fabricated from material or materials comprising iron, steel, aluminium or carbon.

15. A composite electrode comprising a composite conducting material in accordance with claim 1 disposed as an electrode in an electrical circuit.

16. A composite electrode in accordance with claim 15 disposed for use in an electrokinetic system as an anode for the treatment of highly watered or highly saline substrates by electroosmosis.

17. An electrokinetic circuit comprising at least one first electrode, at least one second electrode remotely spaced therefrom with a substrate to be treated lying therebetween, and a means to apply a potential difference thereacross to drive an electroosmostic process within the substrate, wherein at least one of the electrodes is a conducting material in accordance with claim 1.

18. An electrokinetic circuit in accordance with claim 17 wherein at least the electrode intended to function as the anode in use is a conducting material.

19. An electrokinetic circuit comprising at least one first electrode, at least one second electrode remotely spaced therefrom with a substrate to be treated lying therebetween, and a means to apply a potential difference thereacross to drive an electroosmostic process within the substrate, wherein at least one of the electrodes is an electrode in accordance with with claim 15.

20. An electrokinetic circuit in accordance with claim 19 wherein at least the electrode intended to function as the anode in use is an electrode.
